(19) United States
(12) Patent Application Publication
(10) Pub. No.: US 2022/0032233 A1
(43) Pub. Date: Feb. 3, 2022

(54) AN OCEAN WAVE POWERED DESALINATION SYSTEM

(71) Applicant: RESOLUTE MARINE ENERGY, INC., Boston, MA (US)

(72) Inventor: Allan CHERTOK, Bedford, MA (US)

(21) Appl. No.: 17/278,494

(22) PCT Filed: Sep. 24, 2019
(86) PCT No.: PCT/US2019/052632

§ 371 Date: Mar. 22, 2021

Related U.S. Application Data
(60) Provisional application No. 62/735,992, filed on Sep. 25, 2018.

(51) Int. Cl. B01D 61/02; F03B 13/00; B01D 61/06; B01D 61/08; B01D 61/12; C02F 1/44; C02F 1/00

(52) U.S. Cl. CPC B01D 61/025; C02F 2103/08; B01D 61/06; B01D 61/08; B01D 61/12; C02F 1/441; C02F 1/004; C02F 1/008; B01D 2313/243; B01D 2313/246; B01D 2313/34; B01D 2311/2649; B01D 2311/04; B01D 2311/14; B01D 2313/36; F03B 13/00

(57) ABSTRACT

An ocean wave-driven sea water desalination plant employs ocean bottom mounted and hinged flaps driven in oscillating motion by wave surge force to drive rotary pumps which directly pressurize filtered sea water for use by a reverse osmosis (RO) plant and a hydraulic motor-generator set which provides electrical power to RO plant peripheral devices. Means are provided to control the filtered sea water pressure presented to the RO membranes to a preferred set point value. Means are also provided to control the pump reaction torque presented to the flap independently of water pressure by adjusting the effective pump displacement with a pulse width modulated valve shunting the pump ports to maximize captured wave power. Control of pump reaction torque may be effected slowly according to average sea state conditions or in real-time to further enhance captured wave power.

This invention was made with government support under Contract No. DE-SC0017699 awarded by the U.S. Department of Energy. The United States Government has certain rights in the invention(s).

### FIELD OF THE INVENTION

The present invention relates a sea water desalination system employing ocean wave-driven pumps to pressurize a flow of sea water delivered to a plurality of reverse osmosis (RO) membranes and a hydraulic motor-generator set supplying power for RO system peripheral devices.

### BACKGROUND OF THE INVENTION

Over 1 billion people suffer from the effects of water scarcity. Desalinating sea water is an excellent potential solution but traditional reverse osmosis (RO) desalination systems require a connection to an electrical grid or dedicated diesel engine-driven power generator. The disclosed wave-driven desalination system can be deployed quickly, operate completely “off-grid” and supply large quantities of fresh water at a competitive cost. Wave energy is well suited for driving a RO plant as both the energy and raw material (sea water) are co-located.

### PRIOR ART

Present day RO plants employ an electric motor-driven pump to pressurize a portion of the total feed water flow of sea water supplied to the RO membranes which deliver two process streams, namely, 1) fresh water (a/k/a “permeate”) and 2) brine (a/k/a “concentrate”). Typically, a RO plant operates at a controlled “recovery ratio” wherein the permeate flow may be approximately 40% of the total feed water input flow and the rejected concentrate approximately 60%. The feed water input pressure may be approximately 850 psi and the concentrate marginally less-e.g., only 5 psi. The considerable hydraulic power of the concentrate flow is employed by an energy recovery unit (ERU)to pressurize the remaining feed water flow required to maintain the process. The most efficient ERU methods directly transfer concentrate pressure to incoming feed water. Small losses in the process are compensated by an electric motor-driven pump which may be integral to the ERU.

With the benefit of concentrate energy recovery, the electrical energy required to run the feed water pressurization pump, and other supporting devices and controls, may be approximately in the range of 2 to 4 kWh per cubic meter of permeate produced per day (m³/d) according to the scale of the plant. Where grid power is available at a modest cost—e.g., $0.08/kWh—the energy cost of the most efficient RO plants operating at 2 kWh/ m³/d would be an acceptable $0.16/m³/d. However, in remote coastal and island regions, smaller scale plants operating at 4 kWh/m³/d and employing electrical power supplied by a standalone diesel-generator set at a cost of $0.30/kWh would incur a relatively high water production energy cost of $1.20/m³/d. Amortized capital expense (CAPEX) and recurring operating expense (OPEX) might add an additional $1.00/m³/d or more to the associated cost. This high cost water and the negative environmental impact of diesel engine-powered generators motivate the concept of employing captured ocean wave energy in order to drive the RO process.

No ocean wave-driven RO plants—experimental or commercial—are known to be operational today. As reported in Matt Folley, Baltasar Peñate Suarezb, Trevor Whittaker, An autonomous wave-powered desalination system, Science Direct, 2008 (Reference [1]), the first demonstration of a wave-driven RO device was the Delbuoy which produced 2 m³/d circa 1980. DelBuoy employed a linear reciprocating pump driven by wave motion to pressurize feed water delivered to a RO membrane. A proposed contemporary embodiment of the DelBuoy concept disclosed in Reference [1] and in Matt Folley, Trevor Whittaker—The cost of water from an autonomous wave-powered desalination plant, Renewable Energy 34 (2009) 75-81 (Reference [2]), similarly uses wave-driven linear pumps to pressurize the RO plant feed water supply.

As reported in References [1] and [3], an attempt was made circa 2004 to employ electricity generated by an experimental oscillating water column (OWC) wave energy plant in Kerela India to power a RO plant. The energy demand, kWh/ m³/d, of the Kerela electrically powered RO plant, or other wave-to-electric powered system, would be significantly higher than the method of “direct pressurization” demonstrated by DelBuoy, or the contemporary embodiment disclosed in References [1] and [2], since additional power conversion steps and associated losses are incurred:

Wave-driven device mechanical or hydraulic power conversion to electricity;

Electrical power conversion to feed water pump motor shaft power;

Motor shaft power conversion to pump-pressurized RO feed water hydraulic power.

As a consequence, a wave-driven RO system employing direct pressurization of feed water will be less costly to build and operate.

Conventional RO plants supplied with electric power at stable voltage and frequency readily deliver feed water to the RO membranes at constant pressure and hence constant flow. While there is speculation that a fluctuation of pressure and flow will shorten membrane service life, little, if any, research in this regard has been reported. The relatively contemporary prior art wave-driven RO system with direct pressurization of the feed water supply disclosed by References [1] and [2] does not appear to have positive means of controlling this pressure. A pressure exchanger-intensifier device, pressure relief valve and large volume accumulator are provided to suppress and limit pressure fluctuations, but it is not obvious that mean pressure can be regulated to a preferred set point value to minimize any concerns about membrane life degradation.

DelBuoy and the relatively contemporary prior art wave-driven RO system with direct pressurization of the feed water supply disclosed by References [1] and [2] employ wave-driven linear pumps. As these are submerged in the ocean they are subject to development of corrosion and bio-fouling. In particular, the exposed portion of the piston rod is at risk as corrosion and formation of bio-fouling films may wear the pump seals as the rod translates to and fro. A scraper may be provided to remove bio-fouling in advance of the seal and the rod may be formed of an anti-corrosive steel alloy. Nonetheless, over a long period of time, it is to be appreciated residual bio-films and corrosion may shorten the service life of the pump seals.

Another shortcoming of the linear pump configuration, as disclosed in both References [1] and [2], is that the piston rod and seals bear a bending load which may impair their operational life. Moreover, the pump and its piping connections must articulate with that of the wave-driven flap. Hence, there is potential for fatigue failure of pump mechanical connections to the flap and stationary chassis and hydraulic connections to piping.

A further shortcoming of the linear pump configuration, as disclosed in both of References [1] and [2], is that there is no provision for controlling the pump reaction torque presented to the wave-driven flap to maximize wave power capture efficiency. Developed flap mechanical power depends on pump reaction torque load and akin to the operation of electrical sources maximum conversion of incident wave power is converted to flap mechanical power at a particular flap torsional load (a/k/a “flap damping torque”). It is to be appreciated that either too little or too much load will result in sub-optimal power conversion. Pump reaction torque is determined by the RO feed water pressure which may not provide the optimum flap load and, moreover, as explained above, the prior art disclosed by References [1] and [2] provides no means for controlling feed water pressure to a preferred set point value.

### SUMMARY OF THE INVENTION

Wherefore, it is an object of the present invention to overcome the above-mentioned shortcomings and drawbacks associated with the prior art.

The disclosed system, according to the invention, employs an oscillating wave surge converter (OWSC) which comprises an ocean bottom-mounted hinged flap that preferably drives a pair of rotary hydraulic pumps which deliver a pressurized flow of filtered sea water to both (1) on-shore RO membranes and (2) a hydraulic motor-generator set supplying electrical “house power” for peripheral pumps and controls. The generator and hydraulic motor operate at variable speed enabled by a power electronic interface with an energy storage unit (ESU). Variable speed operation of the hydraulic motor enables control of the mean feed water pressure, supplied to the RO membranes, to be at a preferred set point value. Moreover, the disclosed invention provides switch-mode hydraulic means to modulate the effective displacement of the rotary (or possibly linear) hydraulic pumps so that pump reaction torque (Nm), determined by the product of displacement (m³/rad) and pressure (N/m²), may be adjusted independently of RO membrane feed water pressure so that flap load can be set to a value for optimum wave power capture.

A block diagram of the complete RO desalination system and house power generation system, identifying salient components and their interconnection, is depicted by FIG. 1.

A first object of the present invention is to provide means for controlling a mean RO plant feed water pressure to a preferred value as available wave power fluctuates. This is accomplished by adjusting the speed of the hydraulic motor driving the house power electric generator by controlling the generator electric load. Control of hydraulic motor speed determines the rate at which sea water is extracted from a high-pressure accumulator and by this means its pressure can be maintained at a set point value. The fluctuation of generator power accompanying speed adjustment is compensated by the provision of an electrical energy storage unit (ESU) which comprises of a battery, a flywheel, a super-capacitor bank or combination thereof to assure continuous delivery of power to peripheral pumps and controls.

A second object of the present invention is to provide switch-mode means, similar to methods employed in the field of power electronics, to control flap pump reaction torque independently of the RO membrane feed water pressure so flap torsional load can be set to a value for optimum wave power capture while simultaneously achieving a preferred feed water pressure. Such means comprise a valve shunting the pump ports and a method for pulse width modulation (PWM) of the valve state for controlling the effective displacement (m³/rad) of the pump. With a PWM duty cycle of 0, the valve is closed, and no pump fluid is bypassed in which case the effective displacement equals the maximum displacement of the pump, as determined by its interior dimensions and any internal leakage. With a duty cycle of 1, the valve is continuously open, and the effective displacement is zero. For duty cycles between 0 and 1, intermediate values of effective displacement may be readily obtained. By this mechanism, the pump effective displacement and consequent flap loading can be slowly varied over minutes or hours, according to average sea conditions (a/k/a “Coulomb damping control”) or potentially in real-time, e.g., with flap load proportional to flap angular velocity (a/k/a “linear or viscous damping control”) to enhance wave power capture.

A third object of the present invention is to replace the prior art linear pump with an oscillating rotary pump in which all critical working surfaces are fully enclosed and isolated from the surrounding sea water so that the modes of failure, due to bio-fouling and corrosion, are avoided or minimized at the very least. The bearings of a rotary pump may also serve as hinges for the flap and thereby reduce the associated capital expense. Moreover, neither the pump nor its hydraulic connections articulate with flap oscillation thus avoiding the potential for fatigue failures.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. The invention will now be described, by way of example, with reference to the accompanying drawings in which

FIG. 1 is a block diagram identifying all salient components of the system as well as their interconnection.

FIG. 2 is a piping schematic diagram identifying all salient components of the system and their interconnections other than house power conditioning, storage and loads shown in FIG. 1.

FIG. 3 is a diagrammatic plan view of an illustrative wave-driven desalination plant comprising a pair of off-shore ocean bottom-mounted flaps each supported for rotation by a pair of rotary pumps which deliver pressurized, filtered sea water as the feed water supply to an on-shore RO desalination module and a house power generation module via sub-sea pipe lines. The generated house power supports RO plant peripheral devices and controls. Fresh water, produced by the RO module, may be delivered to a holding tank to accommodate fluctuating production and demand flows.

FIG. 4 is a section view of an ocean bottom mounted flap supported by, and torsionally coupled to, one of two rotary pumps. Oscillation of the flap, by wave surge forces, rotates the pump which pressurizes filtered sea water for use as the feed water supply for the RO plant and the house power generator.

FIG. 5 is an isometric view of an illustrative ocean bottom mounted flap supported by a pair of rotary pumps. The flap and pumps are caused to rotate or reciprocate back and forth by wave surge forces.

FIG. 6 is an exploded view of illustrative flap construction which may comprise an outer skin of fiber reinforced plastic (FRP) supported by a steel armature which transfers wave force developed flap torque to a pair of rotary pumps. The pumps also serve as hinges which support the flap for rotation.

FIG. 7a depicts the overall form and nominal dimensions of an illustrative oscillating rotary filtered sea water pressurization pump for use with the invention.

FIG. 7b depicts the salient elements of the illustrative oscillating rotary pump.

FIG. 8a depicts alternative means for pressurizing the filtered sea water using a linear pump rather than preferred rotary sea water pumps wherein the linear pumps are coupled to the oscillating flap by means of a cross-head mechanism to avoid bending stress on the pump rod and articulation of the pumps and their hydraulic connections.

FIG. 8b depicts a section view of the stationary linear pump linkage to the oscillating flap by means of a cross-head mechanism.

FIG. 9 depicts optimal trends of RO feed water pressure and flap pump pressure as a function of available wave power. The lower pump pressure for optimal flap loading and power capture is accommodated by modulating the effective pump displacement—or equivalently the effective pump pressure—with a pulse width modulated shunt valve.

FIG. 10 depicts alternative means for supporting rotation of the flap with a separate pair of bearings and flap pumps torsionally coupled to the flap by levers to facilitate removal and replacement of a failed pumps.

FIG. 11 identifies power flows for an illustrative embodiment.

It should be understood that the drawings are not necessarily to scale and that the disclosed embodiments are sometimes illustrated diagrammatical and in partial views. In certain instances, details which are not necessary for an understanding of this disclosure or which render other details difficult to perceive may have been omitted. It should also be understood that this disclosure is not limited to the particular embodiments illustrated herein.

### DETAILED DESCRIPTION OF THE PREFERRED EMBODIMENTS

The present invention will be understood by reference to the following detailed description, which should be read in conjunction with the appended drawings. It is to be appreciated that the following detailed description of various embodiments is by way of example only and is not meant to limit, in any way, the scope of the present invention.

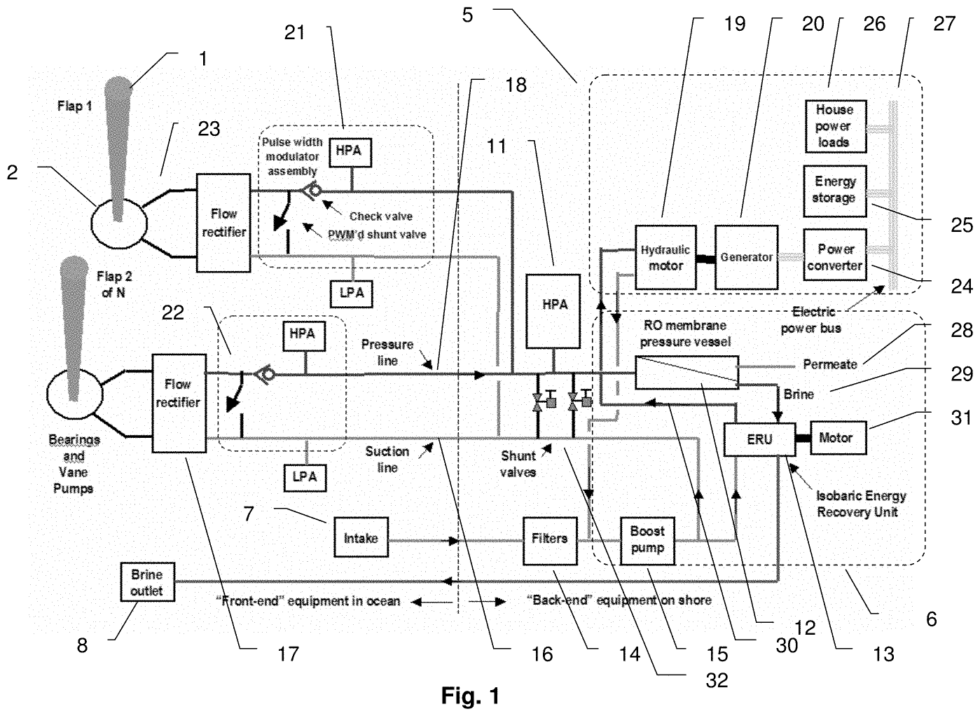

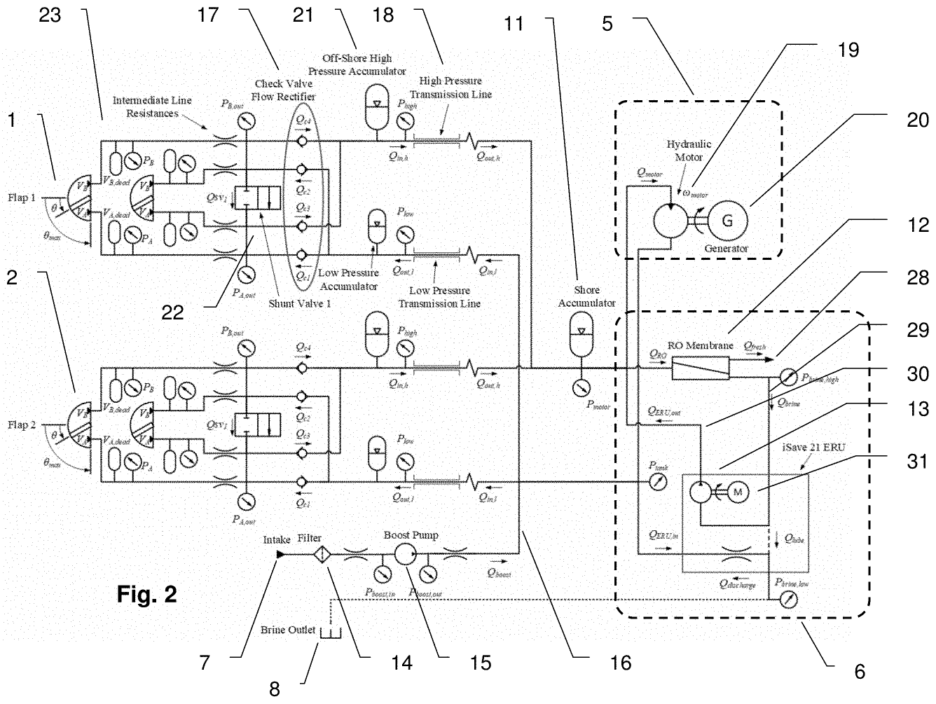

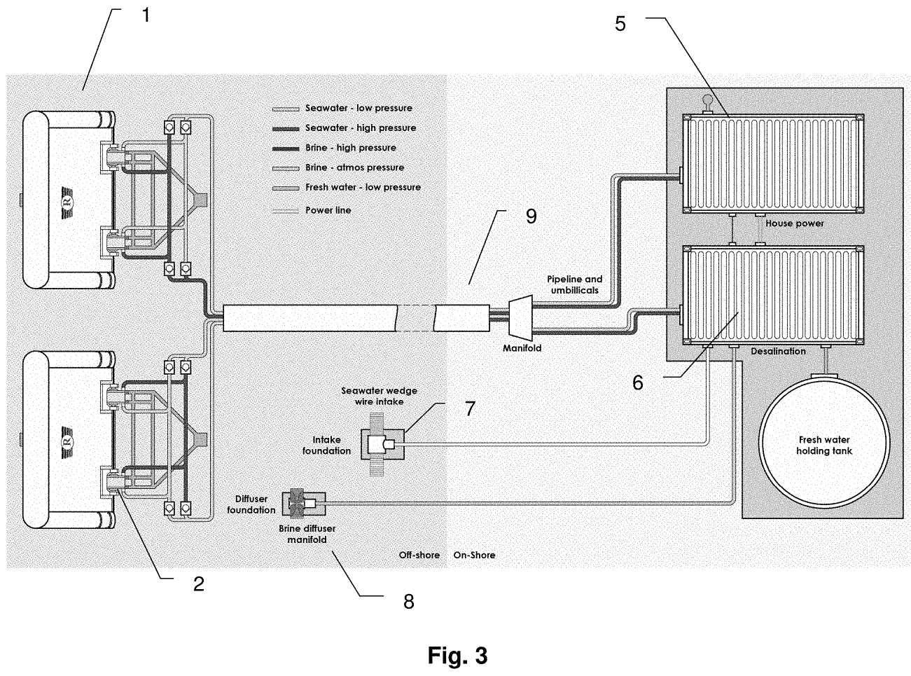

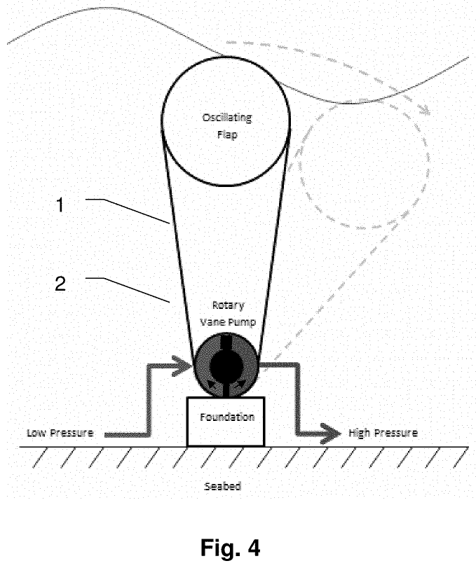

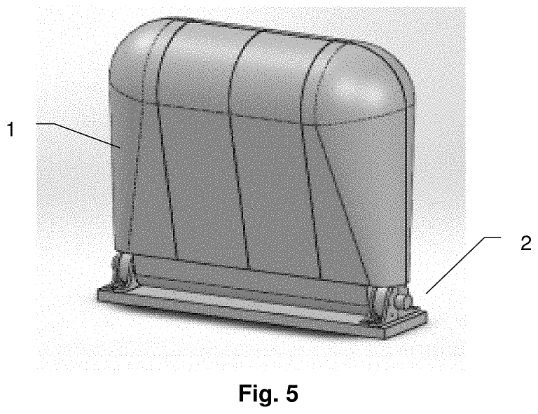

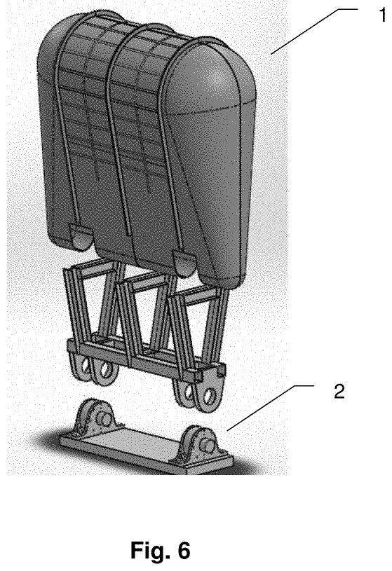

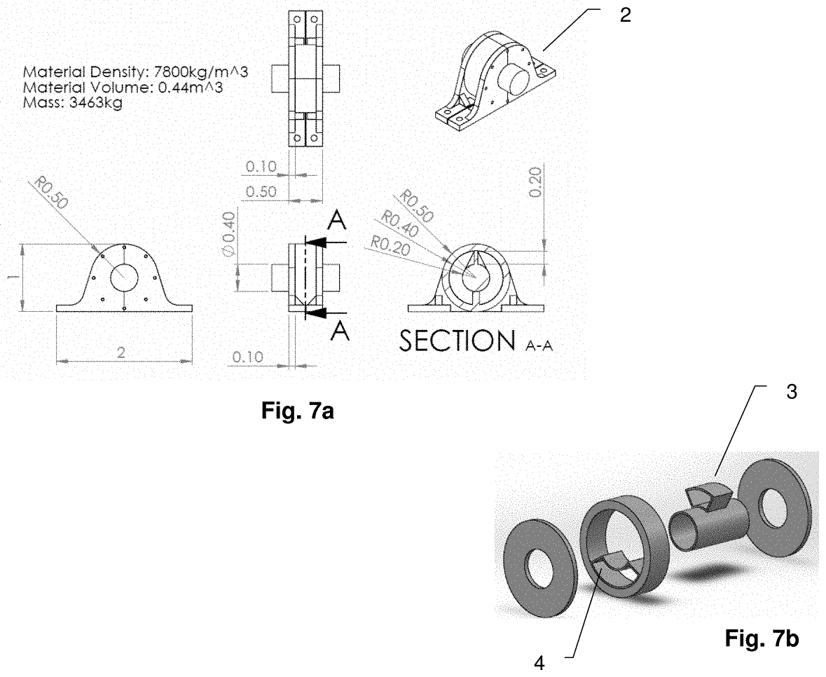

Turning now to the system block diagram of FIG. 1 and corresponding schematic diagram of FIG. 2, a brief description concerning the various components of the present invention will now be briefly discussed. As can be seen in these Figures, the present invention relates to an ocean wave-driven sea water desalination plant. Sea water is drawn in through an intake 7 and then the drawn in sea water passes through one or more filters 14 before passing through a boost pump 15. A first portion of the output flow from the boost pump 15 is delivered, via a respective suction line 16 and a respective flow rectifier 17, to a plurality of flap pumps 2 (four of which are shown in FIG. 2 of the drawings). As may be seen in the block diagram of FIG. 1 and the schematic diagram of FIG. 2, the suction line 16 branches from the boost pump 15 to supply a portion of the filtered sea water to each one of the pair of flap-driven rotary pumps 2 associated with each respect one of the pair of flaps 1—i.e., a total of fourflap-driven rotary pumps. Since the pumps 2 are driven by their respective flaps 1 in an oscillating motion, the check valve flow rectifiers 17, shown in FIG. 2, are provided to resolve the consequent bi-directional flows at pump ports into uni-directional suction line 16 and output pressure line 18.

Referring to FIGS. 1 and 2, it can be seen that the aggregate output of four flap-driven pumps 2 and their associated flow rectifiers 17 deliver a flow of the pressurized filtered sea water (a/k/a “feed water”) to the on-shore RO membranes 12 of the desalination plant 6 and to the hydraulic motor 19 driving the generator 20 of the house power electric system or plant 5.

The angular velocity amplitude of flap 1 fluctuates, as the flap oscillates back and forth, between zero and a maximum value. As a consequence, the rectified output of the flap-driven pumps pulsates at twice wave frequency—e.g., with a period of 5 seconds for waves of 10 second period. Moreover, due to variability of wave height and period the amplitude of these pulses will be modulated by these more slowly fluctuating wave characteristics. An off-shore high pressure accumulator 21 and typically larger volume on-shore accumulator 11, as depicted in FIGS. 1 and 2, are provided to suppress flow and pressure pulsations and fluctuations of feed water supplied to the high-pressure pipe line 18, the RO membranes 12 and the hydraulic motor 19.

As can be seen in FIG. 1, the house power generator 20 delivers its output, via a power converter 24, to an electrical energy storage unit (ESU) 25 and a house power loads 26 which are interconnected with one another by a bus 27. It is to be appreciated that the bus 27 may transport electrical power either in AC or DC format. The principal house power loads are the boost pump 15 and RO energy recovery unit (ERU) 13 shown in FIGS. 1 and 2. Additional smaller loads include computer-based controls as well as LED lighting not shown in any of the figures.

A second portion of the output flow from the boost pump 15, i.e., the portion of boost pump 15 output not flowing to the flap pump suction line 16, is delivered to the RO energy recovery unit (ERU) 13 which transfers much of the pressure in the RO membrane reject concentrate (a/k/a “brine”) to this component of boost pump feed water output. This ERU pressurized supply of feed water 30 joins the pressurized feed water flow supplied to the RO membranes 12 by the flap pumps 2 and flow rectifiers 17 depicted in FIGS. 1 and 2. A pump which integral to the ERU 13 and driven by a motor 31 compensates for any small pressure drop in the pressure transfer process and maintains the output flow 30 at the preferred RO membrane input pressure.

Since the pressure drop from RO membrane feed water input to reject concentrate output is very small—perhaps only 1 percent or less of the feed water pressure—the concentrate hydraulic power is very high and absent the ERU would be wasted and the flow supplied by the flap pumps 2 would have to be much greater to meet a desired RO flow of the permeate 28. As a simplified example, assume zero pressure drop across the RO membrane from the feed water input to concentrate output as well as a 100% efficient ERU. Then, if the desired permeate flow were to be 90 gpm (˜500 m³/d) and the RO process operated at a 50% recovery ratio, the flap pumps 2 would need deliver only 90 gpm since the remaining 50% of the required feed water flow (90 gpm) would be supplied by the ERU.

In practice, a recovery ratio somewhat less than 50% might be desirable to minimize membrane maintenance. Also ERU efficiency would be less than 100% and its loss would be compensated by house power supplied to its internal pump. As recovery ratio declines, more feed water must be supplied to the ERU by the boost pump 15 which increases its size and cost as well as its house power demand. Moreover, the consequent additional feed water hydraulic power demand of the house power generation system would exact a penalty on permeate production capacity. These and other design tradeoffs can be evaluated with a comprehensive computer model of the complete plant depicted by FIGS. 1 and 2.

The performance of a desalination plant of the present invention is rated at a stated permeate productivity Qp (m³/d) at rated sea state conditions—“significant wave height” Hs (m) and “Peak Power Period” Tp (s). Hs is defined as the mean trough to crest height of the highest third of the waves and Tp is the inverse of the frequency at which the value of the wave power frequency spectrum is a maximum. For example, an illustrative system may deliver a permeate flow Qp of 500 m³/d for Hs=2.5 m and Tp=12 s. For these rated conditions, there will be a particular RO plant feed water pressure which achieves Qp at a preferred recovery ratio RR.

Wave power incident on the flaps 1 and developed flap mechanical and flap pump 2 feed water power is proportional to Hs² and Tp.

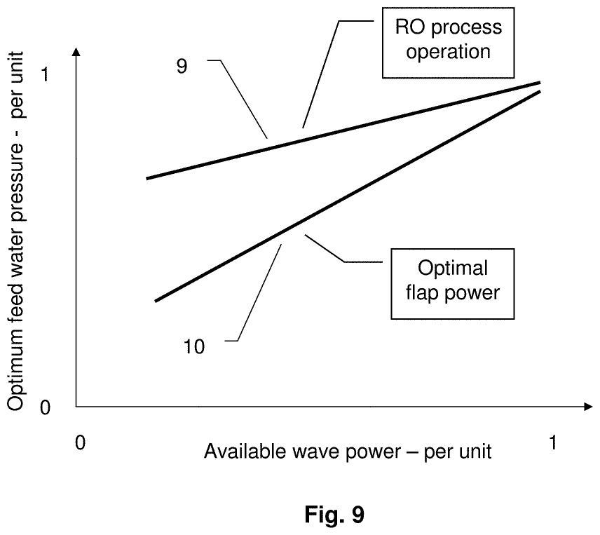

For below-rated sea conditions—in particular Hs<Hs rated—the preferred RO feed water pressure to maintain best permeate flow, at a desired recovery ratio, will be less than the rated pressure, as illustrated by trend line 9 in FIG. 9. By modulating the speed of the house power hydraulic motor 19 and electrical generator 20, the present invention provides control means for regulating RO feed water pressure. If, for example, RO feed water pressure exceeds a set point value—e.g., 800 psi—the motor-generator speed can be increased by momentarily commanding the power converter to reduce generator current and hence its reaction torque presented to the hydraulic motor. As a consequence, the motor will accelerate, the rate at which the motor extracts working fluid from the on-shore and off-shore high pressure accumulators (HPA) 11 and 21 will increase, RO feed water pressure will decline and electric power delivered to the energy storage unit 25 will increase. By employing a proportional (P) or a proportional and integral (PI) closed loop control methods, RO feed water pressure can be maintained at a set point value pre-determined to be preferred for average values of Hs and Tp determined by wave pressure sensors local to the flaps. Alternatively, open loop control methods, such as model predictive control (MPC), might also be used to adjust motor-generator speed to achieve a desired set point RO feed water pressure.

In similar fashion to the preceding example, if RO feed water pressure drops below a set point value, the generator 20 current and reaction torque presented to the hydraulic motor 19 can be momentarily increased to slow down the hydraulic motor 19 and the rate at which fluid is extracted from the HPA 11 to raise RO feed water pressure.

Average sea state parameters Hs and Tp vary relatively slowly—perhaps only significantly over 15 minutes or longer. As the speed of motor 19 and generator 20 fluctuate to maintain a preferred RO feed water pressure, the power developed by the generator will also fluctuate. At the same time, the speed of boost pump 15 and energy recovery unit 13 will also be adjusted and hence their house power demands will also fluctuate. To assure that house power demands are satisfied under varying wave conditions, an energy storage unit (ESU) 25 is provided to buffer generator power output.

As depicted by trend line 10 in FIG. 9, the flap pump pressure and corresponding pump reaction torque for optimum flap power capture also declines with available wave power—and at a faster rate than optimum feed water pressure for the RO process. The flap pumps exert a reaction (a/k/a “damping”) torque on the flaps for which there is an optimal value for maximum wave power capture. If the torque is excessive the flaps will stall. If too little reaction torque is applied less than optimum power will be developed. There is an optimum value in between too little and too much torque. Pump reaction torque (Nm) is determined by the product of displacement (m³/rad) and pressure (N/m²). Since flap pump displacement (m³/rad) is fixed by the dimensions of its cavities and to a lesser extent by its seal leakage, reaction torque control would normally be available only by modulating feed water pressure. However, as may be seen in FIG. 9 for available wave power less than 1.0 per unit the optimum pressure, and hence flap damping torque, is less than that which would be developed by the feed water pressure optimal for the RO process.

The present invention provides control means for achieving optimal flap damping torque while simultaneously setting RO feed water pressure to its optimal value. This control is accomplished by provision of valves 22 which shunt the ports of flap pumps 2 depicted in FIG. 2. The closed/open state of these shunt valves is controlled in a pulse width modulated (PWM) fashion analogous to the ON-OFF operation of transistors in power electronic apparatus. If the valves are closed to prevent fluid flow, the effective flap pump displacement is at its maximum value determined by its chamber dimensions and seal leakage. If the valves are open, allowing fluid to flow freely from one chamber to the other with negligible pressure drop, the effective pump displacement is nominally zero. By switching valves between closed and open conditions in the PWM fashion, with a desired open state duty cycle, flap pump effective displacement can be controlled to determine pump reaction torque and flap damping for optimal power capture while the feed water pressure may be set at an optimum value for the RO process. Additionally, if sea conditions provide more than rated flap mechanical and feed water hydraulic power the PWM duty cycle of shunt valves 22 may be adjusted to reduce developed hydraulic power to its rated limit.

In an illustrative embodiment of the present invention, a shunt valve switching frequency of 1 to 5 Hz may be sufficient for the PWM control.

While shunt valves 22 may be also located across the pressure and suction lines, on the output side of the flow rectifier as depicted in FIG. 1, they are preferably located across the pump ports as shown in FIG. 2. Additional shunt valves 32, as depicted in FIG. 1, maybe provided as back ups to valves 22 to automatically or manually unload the flap and disable the on-shore apparatus under severe wave conditions—e.g., Hs>3.5 m—or to facilitate servicing of the on-shore apparatus.

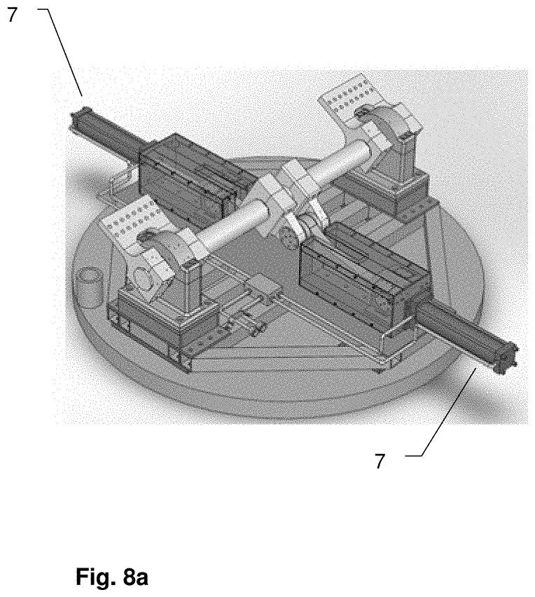

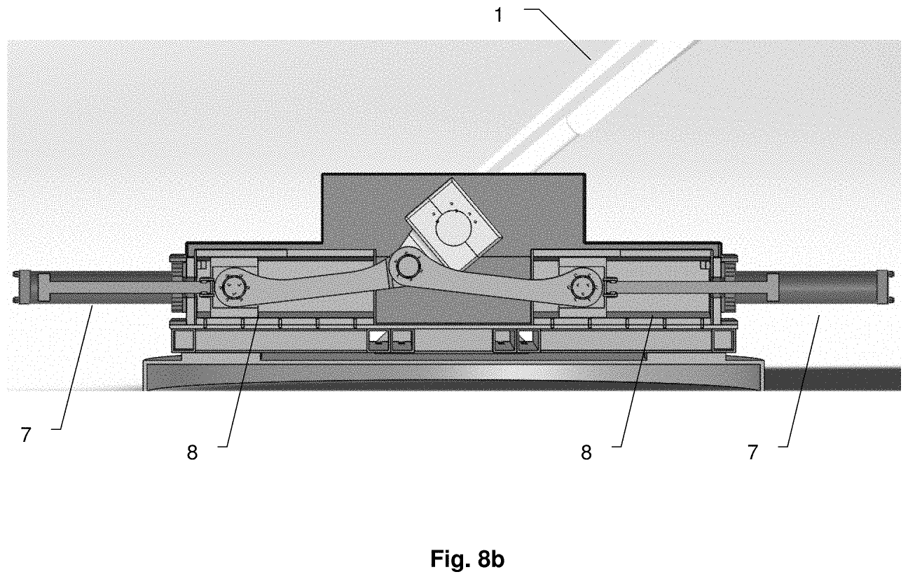

An illustrative embodiment of the present invention includes the interconnected elements depicted in FIG. 1 and/or FIG. 2 with preference given to the shunt valves22 connected across the ports of their respective flap pumps 2, as depicted in FIG. 2. A preferred embodiment would employ rotary flap pumps 2, as depicted in FIGS. 1 and 2, as opposed to cross-head driven linear pumps, as depicted in FIGS. 8a and 8b.

A second embodiment of the present invention only differs from the first embodiment with respect to location of shunt valves 22 connected across the output ports of their respective flow rectifiers 17, as depicted in FIG. 1.

A third embodiment of the present invention differs from the first or second embodiments, described above, only with respect to the choice of flap pumps 2 for which cross-head driven linear pumps would be selected.

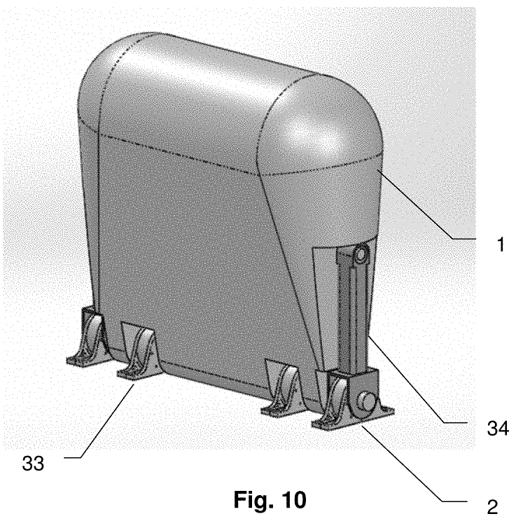

A fourth embodiment of the present invention differ from the first and second embodiment, described above, with respect to provisions made to support rotation of the flaps 1 for which purpose, as depicted in FIG. 10, a separate pair of bearings 33 would be provided and the flap pumps 2 would be torsionally coupled to the flap by levers 34, or by similar coupling means. The motivation for this embodiment is to facilitate removal and replacement of a failed pump.

In all embodiments, an illustrative system of the present invention would have a pair of wave-driven flaps approximately 8 m wide and 7 m tall deployed in a mean sea level depth of 7 m, each driving a pair of rotary pumps 2 or linear pumps 2′ designed to accommodate and pressurize sea water supplied by an on-shore filter 14, boost pump 15 and suction pipe line 16. Filtered sea water thus pressurized to a level in the range of approximately 500 to 1,000 psi (a/k/a “feed water”) would be delivered to membranes 12 of a reverse osmosis (RO) desalination plant and a hydraulic motor 19 driving an electric generator 20 which supplies electrical power to RO plant peripheral devices such as boost pump 15 and energy recovery unit (ERU) 13.

The flap-driven pumps deliver a flow of feed water to the RO membranes 12 nominally equal to the fresh water (a/k/a “permeate”) flow which constitutes a fraction (a/k/a “recovery ratio”) of the total required RO feed water required. The recovery ratio may have an illustrative value of 0.4 per unit (pu). The remaining fraction of the required RO feed water flow—e.g., 0.6 pu—is largely provided by the energy recovery unit which transfers the considerable pressure of the brine (a/k/a “concentrate”) rejected by the RO membranes 12 to the supply of filtered sea water provided by the boost pump.

The feed water pressure may be controlled to a preferred set point value by adjustment of the speed of the hydraulic motor 19 and generator 20 which determines the rate at which water is extracted from the on-shore accumulator 11. Generated electrical power is buffered by an electrical energy storage unit (ESU) 25 to assure that the electrical power demands of RO system peripheral devices can be met as available wave power fluctuates.

The reaction torque of the flap driven pumps 2 or 2′ may be adjusted independently of the feed water pressure by means of the pulse width modulated shunt valves 22 to adjust the effective displacement of the pumps in order to achieve flap damping torque enabling optimum wave power capture. Flap loading can be varied slowly over minutes or hours according to average sea conditions (a/k/a “Coulomb damping control”) or potentially in real-time—e.g., with flap load proportional to flap angular velocity (a/k/a “linear or viscous damping control”) to enhance wave power capture.

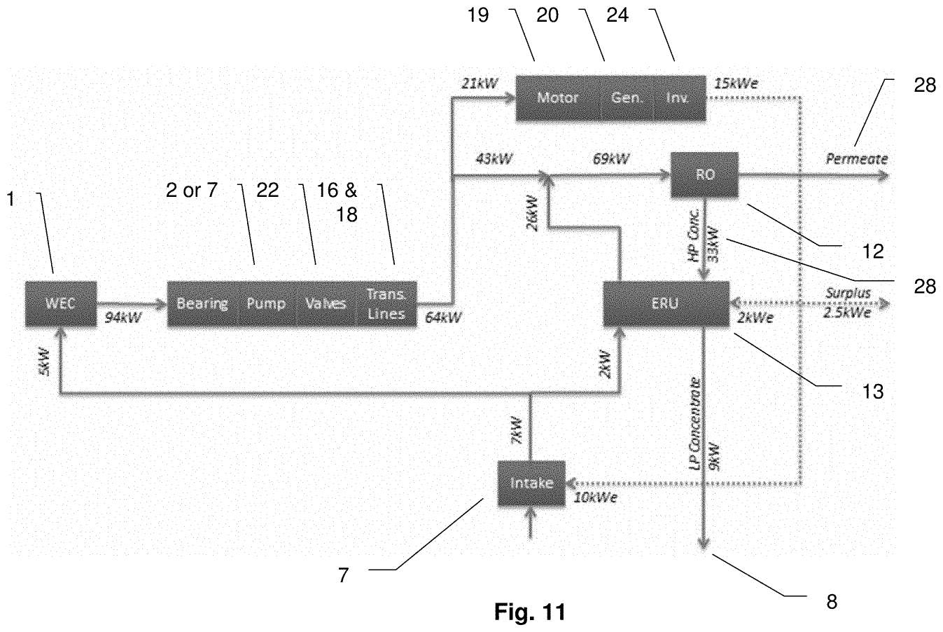

Nominal power flows in all embodiment for rated sea conditions are depicted in FIG. 11.

Additionally, if sea conditions provide more than rated flap mechanical and feed water hydraulic power the PWM duty cycle of shunt valves 22 may be adjusted to reduce developed hydraulic power to its rated limit.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

Wherefore, I claim:

1. An ocean wave-driven sea water desalination plant for generating both fresh water and electrical power from sea water, the desalination plant comprising:
at least one hinged flap for oscillation by wave surge force, the at least one hinged flap driving at least one pump which receives filtered sea water and generates pressurized filtered sea water, and the at least one pump supplying the pressurized filtered sea water to both a house power electric plant and a freshwater generation plant;
the house power electric plant including a hydraulic motor for receiving a first portion the pressurized filtered sea water from the at least one pump and generating electrical power therefrom; and
the freshwater generation plant receiving a second portion of the pressurized filtered sea water from the at least one pump and generating fresh water therefrom;
wherein a speed of the hydraulic motor is varied so as to vary the flow of the first portion of the pressurized filtered sea water through the hydraulic motor and thereby maintain a substantially constant pressure of the first and second portions of the pressurized filtered sea water so that the second portion is supplied to the freshwater generation system at a substantially constant pressure so as to facilitate substantially continuous generation of fresh water during operation of the desalination plant at optimum RO feed water pressure.

2. The ocean wave-driven sea water desalination plant according to claim 1, wherein sea water flows in through an intake and then passes through at least one filter before passing through a boost pump, and the boost pump supplies a first portion of the filtered seawater to the at least one hinged flap while a second portion of the filtered seawater is delivered to an energy recovery unit.

3. The ocean wave-driven sea water desalination plant according to claim 2, wherein the house power electric plant comprises an electrical energy storage unit and a hydraulic motor which drives a generator, and generated electrical power, from the generator, is stored, via a power converter, in the electrical energy storage unit.

4. The ocean wave-driven sea water desalination plant according to claim 3, wherein the house power electric plant further comprises house power loads, and the power converter, the electrical energy storage unit and the house power loads all are interconnected with one another by a bus.

5. The ocean wave-driven sea water desalination plant according to claim 4, wherein the house power electric plant is connected for electrically powering both the boost pump and a RO motor which drives the RO energy recovery unit.

6. The ocean wave-driven sea water desalination plant according to claim 5, wherein a pump of the RO energy recovery unit is driven by the RO motor so as to compensate for any pressure drop in the pressurized filtered sea water supplied to the freshwater generation plant and maintain an output flow from the RO energy recovery unit at a desired RO membrane input pressure.

7. The ocean wave-driven sea water desalination plant according to claim 2, wherein the freshwater generation plant comprises an RO membrane pressure vessel, for receiving the second portion supplied to the freshwater generation system at a substantially constant pressure, and outputting a freshwater permeate as well as a concentrate from the RO membrane pressure vessel which is supplied to the RO energy recovery unit.

8. The ocean wave-driven sea water desalination plant according to claim 3, wherein pressurized feed water, from the energy recovery unit, mixes with the pressurized filtered sea water from the at least one flap valve before flowing into the freshwater generation plant for separation into a permeate and a concentrate.

9. The ocean wave-driven sea water desalination plant according to claim 8, wherein if an RO feed water pressure for the pressurized filtered sea water of the second portion exceeds a set point value, a speed of the hydraulic motor increases to command the power converter to reduce a generator current and hence its reaction torque presented at the hydraulic motor so that the hydraulic motor accelerates and the RO feed water pressure will decline; and, if the RO feed water pressure for the pressurized filtered sea water of the second portion drops below the set point value, the generator current and the reaction torque presented to the hydraulic motor increase to slow down the hydraulic motor and a rate at which the first portion of the pressurized filtered sea water is supplied to the hydraulic motor.

10. The ocean wave-driven sea water desalination plant according to claim 2, wherein one of a proportional control method, a proportional and integral closed loop control method or an open loop control method is employed for maintaining the RO feed water pressure at the desired set point value.

11. The ocean wave-driven sea water desalination plant according to claim 2, wherein the ocean wave-driven sea water desalination plant has at least two hinged flaps and control means for achieving optimal flap damping torque for each hinged flap while simultaneously setting the RO feed water pressure to an optimal value.

12. The ocean wave-driven sea water desalination plant according to claim 11, wherein the control means comprises at least a pair of shunt valves which are located between the boost pump and the at least two hinged flaps, and between the at least two hinged flaps and the freshwater generation plant, and the shunt valves are controlled in a pulse width modulated (PWM) fashion.

13. The ocean wave-driven sea water desalination plant according to claim 2, wherein each of the at least one hinged flap comprises a pair of flap-driven pumps, and each one of the pair of flap-driven pumps is connected to received filtered seawater from the boost pump and to supply the pressurized filtered sea water to the freshwater generation plant.

14. The ocean wave-driven sea water desalination plant according to claim 2, wherein a suction line, branches from the boost pump, and supplies a portion of the filtered sea water to each one of the flap driven pumps, and each one of the flap driven pumps branches into a supply line for supplying the pressurized filtered sea water to the freshwater generation plant.

15. An ocean wave-driven sea water desalination plant for generating both fresh water and electrical power from sea water, the desalination plant comprising:
at least one hinged flap for oscillation by wave surge force, the at least one hinged flap driving at least one pump which receives filtered sea water and generates pressurized filtered sea water, and the at least one pump supplying the pressurized filtered sea water to both a house power electric plant and a freshwater generation plant;
the house power electric plant including a hydraulic motor for receiving a first portion of the output flow of the pressurized filtered sea water from the at least one pump and generating electrical power therefrom; and
the freshwater generation plant receiving a second portion of the output flow of the pressurized filtered sea water from the at least one pump and generating fresh water therefrom;
wherein at least one shunt valve interconnects a filtered sea water inlet supply line to the at least one pump with a pressurized filtered sea water outlet from the at least one pump, and a state of the at least one shunt valve is modulated, during a decrease in the wave surge force from a rated value, in order to attain a pump reaction torque for maximum flap power capture and prevent stalling of the at least one hinged flap and thereby maintain operation of the desalination plant.
